(19) United States
(12) Patent Application Publication
(10) Pub. No.: US 2022/0280932 A1
(43) Pub. Date: Sep. 8, 2022

(54) PIPETTE TIP AND PIPETTE

(71) Applicant: KYOCERA CORPORATION, Kyoto-shi, Kyoto (JP)

(72) Inventor: Tsutomu SUGAWARA, Kirishima-shi, Kagoshima (JP)

(21) Appl. No.: 17/637,079

(22) PCT Filed: Sep. 1, 2020
(86) PCT No.: PCT/JP2020/033053

§ 371 Date: Feb. 22, 2022

(30) Foreign Application Priority Data
Sep. 3, 2019 (JP) 2019-160013

(51) Int. Cl. B01L 3/02

(52) U.S. Cl. CPC B01L 3/02; B01L 3/021; B01L 2200/021

(57) ABSTRACT

In a pipette tip that is open at opposite distal and proximal ends, a glass tube has a first end adjacent to the distal end, a second end adjacent to the proximal end, and a first through hole extending therethrough from the first end to the second end. A connecting member has a second through hole with the glass tube inserted therein. The glass tube is at least partially inserted in the second through hole on one side adjacent to the second end, and is entirely located outside the second through hole on the other side adjacent to the first end. A diameter of an end portion of the connecting member opposite the distal end is greater than a diameter of the distal end of the pipette tip, and the connecting member is made of resin.

### RELATED APPLICATIONS

The present application is a National Phase of International Application No. PCT/JP2020/033053, filed Sep. 1, 2020, which claims priority to Japanese Application No. 2019-160013, filed Sep. 3, 2019.

### TECHNICAL FIELD

The present disclosure relates to a pipette tip and a pipette.

### BACKGROUND ART

A pipette for sucking a liquid and a pipette tip constituting the distal end of the pipette is known (see, e.g., Patent Literatures 1 to 3). Patent Literatures 1 to 3 each disclose a pipette that includes a pipette body and a pipette tip attachable to and detachable from the pipette body.

### CITATION LIST

### Patent Literature

PTL 1: Japanese Unexamined Patent Application Publication No. 2013-156218
PTL 2: Japanese Unexamined Utility Model Registration Application Publication No. 1-132237
PTL 3: International Publication No. 2005/082536

### SUMMARY OF INVENTION

A pipette tip according to an aspect of the present disclosure is a pipette tip that is open at a distal end and a proximal end, which are opposite ends thereof in a length direction. The pipette tip includes a glass tube and a connecting member. The glass tube has a first end adjacent to the distal end, a second end adjacent to the proximal end, and a first through hole extending therethrough from the first end to the second end. The connecting member has a second through hole with the glass tube inserted therein. The glass tube is at least partially inserted in the second through hole on one side of a center position thereof in the length direction, and is entirely located outside the second through hole on the other side of the center position. The one side of the center position is adjacent to the second end and the other side of the center position is adjacent to the first end. A diameter of an end portion of the connecting member opposite the distal end is greater than a diameter of the distal end of the pipette tip. The connecting member is made of resin.

A pipette according to another aspect of the present disclosure includes the pipette tip described above, and a pipette body including an attaching and detaching unit to and from which the connecting member is attached and detached.

### BRIEF DESCRIPTION OF DRAWINGS

FIG. 1 is a diagram schematically illustrating a configuration of a pipette according to a first embodiment.

FIG. 2 is a lateral view illustrating a configuration of a pipette tip of the pipette illustrated in FIG. 1.

FIG. 3 is a cross-sectional view illustrating a part of the pipette tip of FIG. 2 adjacent to a distal end.

FIG. 4 is a cross-sectional view of a connection of a pipette body and the pipette tip illustrated in FIG. 2.

FIG. 5A, FIG. 5B, and FIG. 5C are perspective views for explaining an attaching and detaching structure for attaching and detaching the pipette tip to and from the pipette body.

FIG. 6 is a diagram illustrating a configuration of a main part of a pipette according to a second embodiment.

### DESCRIPTION OF EMBODIMENTS

Embodiments of the present disclosure will now be described with reference to the drawings. Note that the drawings to be referred to in the following description are schematic representations in which dimensional ratios do not necessarily reflect the actual ones. Dimensional ratios in one drawing may differ from those in another drawing.

In the present disclosure, the terms “water repellency (or water repellent)” and “hydrophilicity (or hydrophilic)” are used both in absolute and relative evaluations of properties.

For example, “having water repellency (or being water repellent)” means that the contact angle of a liquid to be sucked into the pipette is greater than or equal to 90° (absolute evaluation). Also, for example, “having hydrophilicity (or being hydrophilic)” means that the contact angle of a liquid to be sucked into the pipette is less than 90°. Note that when the liquid to be sucked into the pipette is not specified, the determination of water repellency and hydrophilicity may be made using the contact angle of water.

On the other hand, for example, having “high water repellency”, “low water repellency”, or “different levels of water repellency” means that when the contact angles of a liquid (or water) to be sucked into the pipette are compared between two members (regions) in contact with the liquid, one contact angle is greater than, smaller than, or different from the other contact angle (relative evaluation). Accordingly, for example, if the water repellency of a first member is higher than the water repellency of a second member, it is not necessarily required that both the first member and the second member, or the second member, have water repellency. The first member and the second member, or the second member, may have hydrophilicity.

### First Embodiment

### [Overview of Pipette]

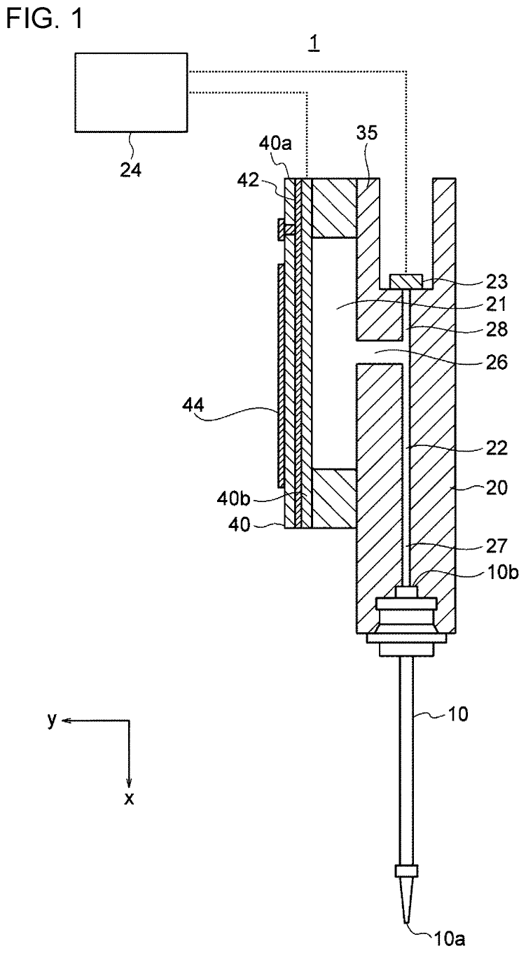

FIG. 1 is a diagram (mainly a cross-sectional view) schematically illustrating a configuration of a pipette 1 according to an embodiment of the present disclosure. Note that the drawings are provided with a rectangular coordinate system xy for convenience. A +x side corresponds to the lower side during sucking of liquid into the pipette 1.

The pipette 1 includes a pipette tip 10 and a pipette body 20 to and from which the pipette tip 10 is to be attached and detached. In FIG. 1, the pipette tip 10 is illustrated in a lateral view, a structural part of the pipette body 20 is illustrated in a schematic cross-sectional view, and a control unit 24 of the pipette body 20 is illustrated in a block diagram.

The pipette tip 10 is hollow throughout from a distal end 10a thereof (end portion on the +x side) to a proximal end 10b thereof (end portion on the −x side). When the pipette body 20 exhausts air from (or reduces pressure inside) the pipette tip 10 through the proximal end 10b, with the distal end 10a in contact with liquid, the liquid is sucked through the distal end 10a into the pipette tip 10. The pipette tip 10 may be, for example, a disposable member. Note that the terms “distal end” and “proximal end” may refer to a distal end face and a proximal end face, or may refer to portions having certain lengths (i.e., a distal end portion and a proximal end portion) including the distal end face and the proximal end face. The same applies to other components.

### [Pipette Tip]

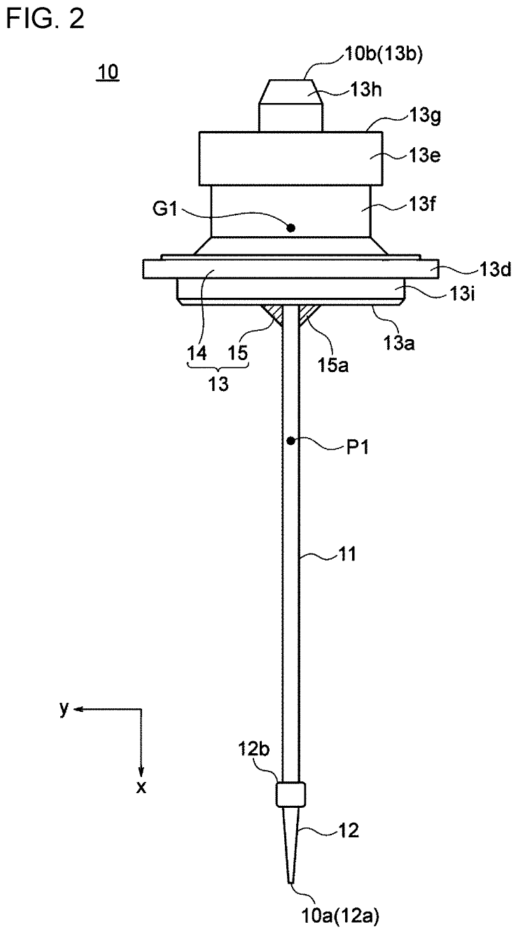

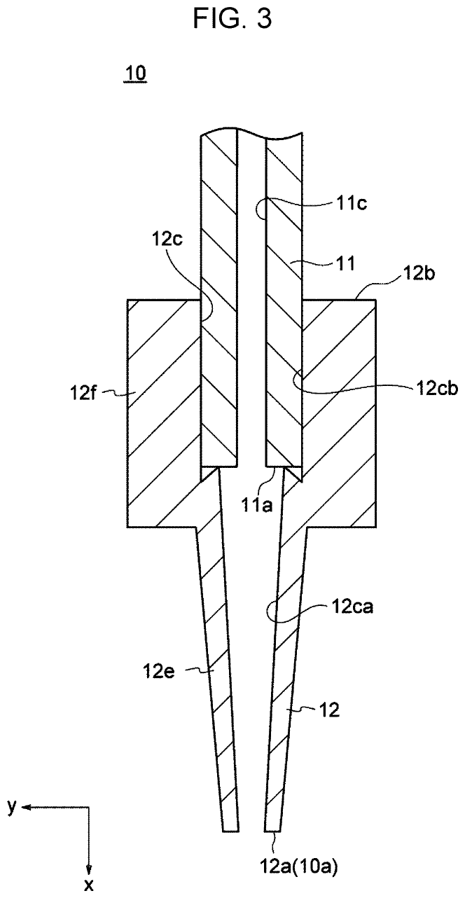

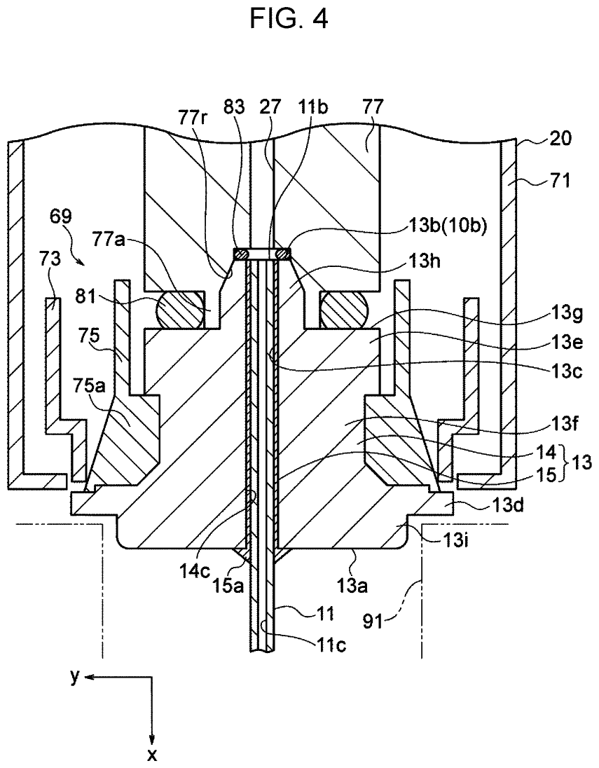

FIG. 2 is a lateral view illustrating a configuration of the pipette tip 10 (and also gives a cross-sectional view of an inner layer 15, described below). FIG. 3 is a cross-sectional view of a part of the pipette tip 10 adjacent to the distal end 10a. FIG. 4 is a cross-sectional view illustrating a part of the pipette tip 10 adjacent to the proximal end 10b (and a part of the pipette body 20 on the distal side).

The pipette tip 10 includes a glass tube 11, a tip member 12 secured to a distal end of the glass tube 11 (on the +x side), and a connecting member 13 secured to a proximal end of the glass tube 11 (on the −x side). The glass tube 11 serves, for example, as a main component of the pipette tip 10. The tip member 12 constitutes a part of the pipette tip 10 adjacent to the distal end 10a and contributes, for example, to improved characteristics of the part adjacent to the distal end 10a. The connecting member 13 constitutes a part of the pipette tip 10 adjacent to the proximal end 10b and contributes, for example, to easy attachment and detachment of the part adjacent to the proximal end 10b, to and from the pipette body 20.

### (Glass Tube)

The glass tube 11 has a distal end 11a (see FIG. 3) and a proximal end 11b (see FIG. 4), which are opposite ends thereof in the length direction (x direction), and also has a through hole 11c extending therethrough from the distal end 11a to the proximal end 11b. In other words, the glass tube 11 has a cylindrical shape. The term “cylindrical shape” refers to, for example, a hollow shape which is long in one direction (i.e., a length in the one direction is greater than a length in the other direction) and open at both ends, and does not refer only to a circular cylindrical shape.

The glass tube 11 may have various shapes. In the illustrated example, the glass tube 11 linearly extends with a constant cross section (or constant inside and outside diameters, from another viewpoint) along the entire length. The shape of the cross section (or the shapes of the inner and outer edges) is, for example, circular. The shape of the glass tube 11, which extends with a constant cross section here, may vary within tolerance. The magnitude of tolerance varies, for example, depending on the dimensions and applications of the glass tube 11. For example, the diameter of the glass tube 11 may have a dimensional variation of about ±15%, ±10%, or ±5%.

The glass tube 11 may have various shapes other than that in the illustrated example. For example, at least part of the glass tube 11 along its entire length may change in cross-sectional shape and size, may warp or bend as it extends, may have a cross section with inner and outer edges of different shapes, or may have a non-circular cross section. Also, for example, a part of the glass tube 11 on the distal side may have a tapered shape that narrows toward the distal end 11a.

The dimensions of the glass tube 11 may be appropriately set depending on various circumstances, such as the amount of liquid to be collected and/or how the collected liquid is to be analyzed. For example, the inside diameter of the glass tube 11 may be greater than or equal to 0.1 mm and less than or equal to 0.3 mm. For example, the outside diameter of the glass tube 11 may be greater than or equal to 0.4 mm and less than or equal to 1.2 mm. Also, for example, the length of the glass tube 11 may be greater than or equal to 20 mm and less than or equal to 100 mm.

The entire glass tube 11 is, for example, integrally formed of the same glass material. The surface of the glass tube 11 may at least partially have a film (e.g., water-repellent film) made of a non-glass material. Also, for example, one part and another of the glass tube 11 in the length direction may be made of different materials, and/or one part and another of the glass tube 11 in the radial direction may be made of different materials.

Examples of the glass include one that is primarily composed of silicate (silicate glass). Examples of the silicate glass include soda-lime glass, borosilicate glass, and silica glass. A glass primarily composed of a material other than silicate may be used. Examples of such glass include acrylic glass, chalcogenide glass, metallic glass, and organic glass.

At least part of the glass tube 11 (i.e., part of or the entire glass tube 11) may have light transmitting properties. This allows, for example, the composition and/or properties of liquid in the glass tube 11 to be examined by irradiating the liquid with light from the lateral side of the glass tube 11. More specifically, for example, fluorescence measurement, scatter measurement, absorbance measurement, and/or spectrometric measurement may be performed.

At least part of the surface (e.g., part of or the entire inner surface) of the glass tube 11 may be provided with a water-repellent film thereon to acquire water repellency. When the glass tube 11 has water repellency, the contact angle of water on the glass tube 11 may be appropriately set. For example, the contact angle may be greater than or equal to 90° and less than or equal to 95° (i.e., approximately 90°), greater than or equal to 95° and less than or equal to 150°, or greater than 150°. Note that if the contact angle is greater than 150°, the glass tube 11 may be considered as having so-called superhydrophobicity.

### (Tip Member)

As illustrated in FIG. 3, the tip member 12 has a distal end 12a and a proximal end 12b, which are opposite ends thereof in the x direction (length direction of the pipette tip 10), and also has a through hole 12c extending therethrough from the distal end 12a to the proximal end 12b. In other words, the tip member 12 has a cylindrical shape. The distal end 12a constitutes the distal end 10a of the pipette tip 10. The through hole 12c is concentrically connected to (or continuous with) the through hole 11c in the glass tube 11. This allows the liquid sucked through the distal end 12a of the tip member 12 to move into the glass tube 11.

The tip member 12 may have various shapes. In the illustrated example, the tip member 12 externally has a first portion 12e with the distal end 12a and a second portion 12f with the proximal end 12b. The first portion 12e has a tapered shape with a smaller diameter on the distal side. The second portion 12f extends with a constant cross section, whose diameter is greater than the diameter of a cross section at the proximal end of the first portion 12e. The cross sections of the first portion 12e and the second portion 12f are, for example, circular in shape.

The tip member 12 may have various external shapes other than that in the illustrated example. For example, the tip member 12 may have an external shape that does not allow the first portion 12e and the second portion 12f to be identified as two different portions. The tip member 12 may have an external shape with a constant cross section throughout its length, or may be externally tapered throughout its length. Externally, the tip member 12 may at least partially have a non-circular cross section.

Also, in the illustrated example, the tip member 12 internally has a first hole 12ca that is open at the distal end 12a and a second hole 12cb that is open at the proximal end 12b. The through hole 12c, described above, is composed of the first hole 12ca and the second hole 12cb. The first hole 12ca is connected at the proximal end thereof to the distal end of the through hole 11c in the glass tube 11. The second hole 12cb is a hole in which a part of the glass tube 11 adjacent to the distal end 11a is inserted.

The shapes of the first hole 12ca and the second hole 12cb may also be appropriately set. For example, the first hole 12ca has a tapered shape with a smaller diameter on the distal side. The second hole 12cb extends with a constant cross section, whose diameter is greater than the diameter of a cross section at the proximal end of the first hole 12ca. The cross sections of the first hole 12ca and the second hole 12cb are, for example, circular in shape. The proximal end of the first hole 12ca is located inside the second portion 12f.

The tip member 12 may have various internal shapes other than that in the illustrated example. For example, the tip member 12 may have an internal shape that does not allow the first hole 12ca and the second hole 12cb to be identified as two different holes. The tip member 12 may not be internally tapered, or may be internally tapered throughout its length. The through hole 12c in the tip member 12 may at least partially warp or bend as it extends, or may have a non-circular cross section. The tip member 12 may have a cross section with inner and outer edges of different shapes.

The tip member 12 is made of a material different from the material of the glass tube 11. This makes it easier to set the properties (e.g., water repellency) of the distal end portion of the pipette tip 10. For example, the glass tube 11 is made of glass, whereas the tip member 12 is made of resin having a higher water repellency than the glass. Thus, for example, without forming a water-repellent film on the surface of the glass tube 11, it is possible to improve the water repellency of the distal end portion of the pipette tip 10 and reduce unintended adhesion of liquid to the distal end portion.

The resin used to form the tip member 12 may be of any appropriate type. Examples of the resin include polypropylene, polyethylene, and polytetrafluoroethylene. The resin may contain a filler made of an organic material, an inorganic material, an insulating material, and/or a conductive material. For example, the entire tip member 12 is integrally formed of the same resin. At least part of the surface of the tip member 12 may have thereon a film (e.g., water-repellent film) made of a non-resin material. Also, for example, one part and another of the tip member 12 in the length direction may be made of different materials, and/or one part and another of the tip member 12 in the radial direction may be made of different materials.

When the tip member 12 has water repellency, the contact angle may be appropriately set. For example, the contact angle may be greater than or equal to 90° and less than or equal to 95° (i.e., approximately 90°), greater than or equal to 95° and less than or equal to 150°, or greater than 150°. Note that if the contact angle is greater than 150°, the tip member 12 may be considered as having so-called superhydrophobicity.

The material of the tip member 12 may be a light-transmitting material or a non-light-transmitting material. Using a light-transmitting material can facilitate, for example, visual checking of liquid sucked into the tip member 12. When the material of the tip member 12 has light transmitting properties, the material of the glass tube 11 may be, for example, a material having a higher light transmittance than the material of the tip member 12. In this case, for example, a material having a high water repellency may be selected as the material of the tip member 12, whereas for analysis of liquid, a material suitable for lateral irradiation of the liquid with light may be selected as the material of the glass tube 11.

Any appropriate method may be used to secure the tip member 12 to the glass tube 11. In the illustrated example, the glass tube 11 and the tip member 12 are secured by press-fitting the glass tube 11 into the second hole 12cb in the tip member 12. The distal end 11a of the glass tube 11 is pressed against a stepped portion defined by the first hole 12ca and the second hole 12cb having a larger diameter than the first hole 12ca. The glass tube 11 is prevented from coming off the second hole 12cb, for example, by frictional force generated by direct contact of the glass tube 11 and the tip member 12. While not specifically shown, the tip member 12 and the glass tube 11 may be provided with packing therebetween. The packing is made of a material of lower stiffness than the tip member 12 and the glass tube 11.

Various methods, other than that in the illustrated example, may be used to secure the tip member 12 to the glass tube 11. For example, the tip member 12 may be secured to the glass tube 11 by locking with pawls, by bonding with an adhesive, or by welding. Unlike the illustrated example, the tip member 12 may be press-fitted into a through hole in the glass tube 11. Two or more of the various methods described above may be used in combination to secure the tip member 12 and the glass tube 11 together. In the illustrated example, for example, the tip member 12 and the glass tube 11 may be provided with an adhesive interposed therebetween. To produce the tip member 12, for example, a resin to be formed into the tip member 12 may be charged into a mold where the glass tube 11 is placed.

### (Connecting Member)

As illustrated in FIG. 2 and FIG. 4, the connecting member 13 has a distal end 13a and a proximal end 13b, which are opposite ends thereof in the x direction (length direction of the pipette tip 10), and also has a through hole 13c extending therethrough from the distal end 13a to the proximal end 13b. The proximal end 13b constitutes, for example, the proximal end 10b of the pipette tip 10 and is located inside the pipette body 20. The through hole 13c has therein a portion of the glass tube 11 adjacent to the proximal end 11b. This allows the through hole 11c in the glass tube 11 to communicate with the interior of the pipette body 20. The proximal end 11b of the glass tube 11 also constitutes the proximal end 10b of the pipette tip 10.

The connecting member 13 may have various shapes. For example, the inner surface of the through hole 13c coincides with the outer surface of the glass tube 11. More specifically, the through hole 13c linearly extends with a constant cross section, which is circular in shape. In the illustrated example, as viewed from outside, the connecting member 13 has a circular cross section, with the through hole 13c at the center. At the same time, the connecting member 13 varies in diameter depending on the position in the length direction of the pipette tip 10.

Specifically, in the illustrated example, the connecting member 13 has a first large-diameter portion 13d having a diameter greater than those of the other portions (i.e., having the largest diameter in the connecting member 13). From another viewpoint, the first large-diameter portion 13d includes a flange that protrudes from the lateral surface of the connecting member 13. The first large-diameter portion 13d contributes, for example, to easy attachment and detachment of the connecting member 13 to and from the pipette body 20, and/or to easy handling of the pipette tip 10, as described below. The shape and diameter of the first large-diameter portion 13d may be appropriately set by taking into consideration the operation and other factors described below.

The connecting member 13 has a second large-diameter portion 13e at a distance from the first large-diameter portion 13d toward the proximal end 10b of the pipette tip 10. The second large-diameter portion 13e is greater in diameter than a first small-diameter portion 13f between the first large-diameter portion 13d and the second large-diameter portion 13e. From another viewpoint, the second large-diameter portion 13e includes a flange that protrudes from the lateral surface of the connecting member 13. From yet another viewpoint, the connecting member 13 has a groove (no reference numeral) formed in the lateral surface thereof by the first small-diameter portion 13f having a relatively small diameter. The second large-diameter portion 13e contributes, for example, to easy attachment and detachment of the connecting member 13 to and from the pipette body 20, as described below. The shape and diameter of the second large-diameter portion 13e may be appropriately set by taking into consideration the operation and other factors described below. Unlike the illustrated example, the diameter of the second large-diameter portion 13e may be substantially the same as or greater than the diameter of the first large-diameter portion 13d.

The connecting member 13 has a protruding portion 13h protruding from a proximal surface 13g facing the proximal end 10b (−x side) of the pipette tip 10. The proximal surface 13g is, for example, a surface of the second large-diameter portion 13e adjacent to the proximal end 10b. The proximal end (top surface) of the protruding portion 13h constitutes the proximal end 13b (proximal end face) of the connecting member 13. In other words, the connecting member 13 has a small-diameter portion including the proximal end 13b (or at least part of the proximal end 13b) and having a relatively small diameter. The protruding portion 13h contributes, for example, to positioning of the connecting member 13 with respect to the pipette body 20, as described below. The shape and diameter of the protruding portion 13h may be appropriately set by taking into consideration the operation and other factors described below. For example, at least part of the protruding portion 13h, including the proximal end 13b, has a tapered shape with a smaller diameter on the proximal side (−x side). The diameter of the protruding portion 13h is, for example, smaller than those of the other portions of the connecting member 13 (except an inner layer 15 described below).

Although the protruding portion 13h (proximal end 13b) has the smallest diameter in the connecting member 13 as described above, the diameter of the protruding portion 13h is greater than the diameter of at least the glass tube 11 (the entire glass tube 11 or the proximal end 11b), as is obvious from the fact that the protruding portion 13h has the glass tube 11 inserted therein. Also, the diameter of the protruding portion 13h is greater than the diameter of the distal end 10a of the pipette tip 10 (or the distal end 12a of the tip member 12 in the present embodiment). When the pipette tip 10 is not attached to the pipette body 20, for example, the shapes of the tip member 12 and the connecting member 13 allow reasonable determination of which end of the pipette tip 10 is to be in contact with liquid or to be attached to the pipette body 20. For example, the fact that the diameter of one end (proximal end 13b of the connecting member 13) is greater than the diameter of the other end (distal end 10a of the pipette tip 10) may be used to make this determination.

The connecting member 13 has, on the distal side (+x side) of the first large-diameter portion 13d, a second small-diameter portion 13i having a smaller diameter than the first large-diameter portion 13d. For example, the second small-diameter portion 13i is next to the distal side of the first large-diameter portion 13d. The second small-diameter portion 13i constitutes the distal end 13a of the connecting member 13. The second small-diameter portion 13i contributes, for example, to protection of the glass tube 11 as described below. The shape and diameter of the second small-diameter portion 13i may be appropriately set by taking into consideration the operation and other factors described below. For example, at least part of the second small-diameter portion 13i, including the distal end 13a, has a tapered shape with a smaller diameter on the distal side. Also, for example, the diameter of the second small-diameter portion 13i may be greater than the diameter of the first small-diameter portion 13f (as in the illustrated example), or may be substantially the same as or smaller than the diameter of the first small-diameter portion 13f.

The connecting member 13 is made of a material different from the material of the glass tube 11. For example, this makes it easier to form the connecting member 13 into any shape suitable for the attaching and detaching structure, and improves strength and/or hermeticity related to the attaching and detaching operation. For example, the connecting member 13 is entirely made of resin.

The entire connecting member 13 may be integrally formed of a single material, or may be formed by combining components made of different materials. In the illustrated example, the connecting member 13 includes a connecting member body 14 and the inner layer 15 interposed between the connecting member body 14 and the glass tube 11. The connecting member body 14 serves, for example, as a main component of the connecting member 13. The inner layer 15 is, for example, an adhesive layer that contributes to securing of the connecting member body 14 to the glass tube 11 in the production process. For example, the connecting member body 14 and the inner layer 15 are made of different resins.

Basically, the description of the shape of the connecting member 13 may be used to describe the shape of the connecting member body 14. Note, however, that the inside diameter of a through hole 14c formed in the connecting member body 14 is greater than the outside diameter of the glass tube 11 by the thickness of the inner layer 15. For example, the through hole 14c has an inner surface that can face the outer surface of the glass tube 11, with a substantially uniform gap therebetween. More specifically, for example, the through hole 14c linearly extends with a constant cross section, which is circular in shape.

The inner layer 15 closely adheres to the inner surface of the through hole 14c and the outer periphery of the glass tube 11. In other words, the inner layer 15 surrounds the outer periphery of the glass tube 11. The connecting member body 14 surrounds the outer surface of the inner layer 15 to constitute the outer periphery of the connecting member 13. The thickness of the inner layer 15 is, for example, substantially uniform. However, for example, the inner layer 15 may have thicker and thinner portions formed when the glass tube 11 is positioned eccentrically, or at an angle, with respect to the through hole 14c while the inner layer 15 is being cured.

In the illustrated example, the inner layer 15 has an extending portion 15a protruding out of the through hole 14c on the distal side (+x side). For example, the extending portion 15a closely adheres to the outer periphery of a portion of the glass tube 11 extending out of the connecting member body 14 toward the distal end 11a. At the same time, the extending portion 15a closely adheres to a surface of the connecting member body 14 on the distal side (or a surface of the second small-diameter portion 13i on the distal side, in the illustrated example). The extending portion 15a has, for example, a tapered shape with a smaller diameter on the distal side (+x side). Note, however, that the inner layer 15 does not necessarily need to have the extending portion 15a.

The resin used to form the connecting member body 14 may be of any appropriate type. Examples of the resin include polycarbonate, acrylic resin, polyacetal, polyamide, modified polyphenylene ether, and polybutylene telephthalate. The type of resin used to form the inner layer 15 may also be appropriately set. Examples of the resin include epoxy resin, acrylic resin, and urethane resin. The resins used to form the connecting member body 14 and the inner layer 15 may contain a filler made of an organic material, an inorganic material, an insulating material, and/or a conductive material.

The relation between various physical property values of the resin forming the connecting member body 14 and the resin forming the inner layer 15 may be appropriately set. For example, the coefficient of linear expansion and/or Young's modulus (or hardness) of one of the resins may be greater than, or substantially the same as, those of the other resin.

The materials of the connecting member 13 (including the connecting member body 14 and the inner layer 15) may be light-transmitting materials, or non-light-transmitting materials. Using light-transmitting materials can facilitate, for example, visual checking of liquid sucked to the connecting member 13. When the materials of the connecting member 13 have light transmitting properties, the material of the glass tube 11 may be, for example, a material having a higher light transmittance than the materials of the connecting member 13.

In the illustrated example, the glass tube 11 is secured to the connecting member 13 by the inner layer 15 serving as an adhesive layer, as can be understood from the description above. For example, an adhesive to be formed into the inner layer 15 is applied to the outer periphery of a part of the glass tube 11 adjacent to the proximal end 11b. Then, the glass tube 11 is inserted into the through hole 14c in the connecting member body 14, with the proximal end 11b first. Residual adhesive around the glass tube 11 collects on the distal side of the connecting member body 14, without entering the through hole 14c, to form the extending portion 15a of the inner layer 15. Unlike the illustrated example, an adhesive to be formed into the inner layer 15 may be applied to the inner surface of the connecting member body 14.

### (Relative Position of Glass Tube to Other Components)

A position in the center of the glass tube 11 in the length direction is defined as a center position P1 (see FIG. 2). That is, the center position P1 is a position equidistant from the distal end 11a and the proximal end 11b. For example, the glass tube 11 is inserted in the connecting member 13 (or the connecting member body 14; the same applies to the rest of the present paragraph) on only one side of the center position P1 adjacent to the proximal end 11b. More specifically, for example, of three segments into which the glass tube 11 is equally divided along its entire length, only a segment adjacent to the proximal end 11b is inserted in the connecting member 13. In other words, the glass tube 11 is located outside the connecting member 13 on the other side of the center position P1 adjacent to the distal end 11a. More specifically, at least ⅔ of the entire length of the glass tube 11 is located outside the connecting member 13.

In the illustrated example, a part of the glass tube 11 adjacent to the distal end 11a is covered with the tip member 12. The length of this part is relatively short. Accordingly, a longer part of the glass tube 11 is located outside the connecting member 13 (or the connecting member body 14) and the tip member 12 (i.e., exposed to the outside). The length of the part exposed to the outside is, for example, greater than or equal to half the length of the glass tube 11, or greater than or equal to ⅔ of the length of the glass tube 11.

A part of the glass tube 11 on one side of the connecting member 13 (or the connecting member body 14) adjacent to the distal end 11a may have, for example, a portion that extends with constant outside and inside diameters. From another viewpoint, a part of the glass tube 11 exposed to the outside (i.e., located outside the connecting member 13 and the tip member 12) may have a portion that extends with constant outside and inside diameters. In the illustrated example, as described above, the glass tube 11 has constant outside and inside diameters along its entire length.

As illustrated in FIG. 4, the proximal end 11b (proximal end face) of the glass tube 11 may be flush with the proximal end 13b (proximal end face) of the connecting member 13 (or the connecting member body 14; the same applies to the rest of the present paragraph). Note however that some displacement between the proximal end 11b and the proximal end 13b is acceptable here. Unlike the illustrated example, the proximal end 11b may be located on the distal side (+x side) of the proximal end 13b, or conversely on the proximal side (−x side) of the proximal end 13b.

### (Center of Gravity of Pipette Tip)

As illustrated in FIG. 2, the center of gravity G1 of the pipette tip 10 is located on one side of the first large-diameter portion 13d adjacent to the proximal end 10b. For example, the center of gravity G1 is located substantially on the center line of the pipette tip 10. The distance from the center of gravity G1 to the first large-diameter portion 13d (i.e., to the proximal end of the first large-diameter portion 13d) may be appropriately set, for example, by taking into consideration the operation and other factors described below. Unlike the illustrated example, the center of gravity G1 may be located on the other side of the first large-diameter portion 13d adjacent to the distal end 10a.

### (Attaching and Detaching Structure for Pipette Tip)

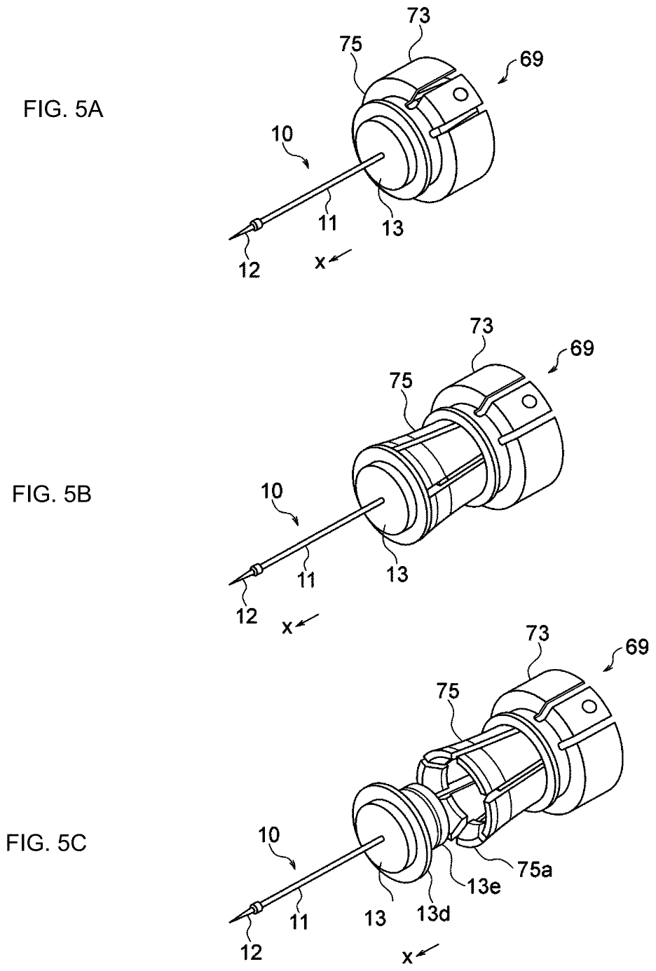

FIG. 5A to FIG. 5C are perspective views for explaining an attaching and detaching structure (attaching and detaching mechanism) for attaching and detaching the pipette tip 10 to and from the pipette body 20. FIG. 5A illustrates the pipette tip 10 attached in place. FIG. 5C illustrates the pipette tip 10 yet to be attached or already detached. FIG. 5B illustrates a state of transition between FIG. 5A and FIG. 5C.

The pipette body 20 includes an attaching and detaching unit 69 for attaching and detaching the pipette tip 10. The attaching and detaching unit 69 is constituted by a collet chuck used, for example, in cutting tools and mechanical pencils. The type and shape of the collet chuck may be appropriately set.

In the example illustrated in FIG. 4 and FIG. 5A to FIG. 5C, the pipette body 20 includes a body 73 secured, for example, to a housing 71 of the pipette body 20, and a collet 75 configured to be movable relative to the body 73 in the axial direction (x direction). The body 73 is substantially circular cylindrical in shape. The collet 75 is a substantially circular cylindrical member capable of being inserted into the body 73. The collet 75 has, at multiple points (six points in the illustrated example) around the axis, a plurality of slits (no reference numeral) that extend in the axial direction from an edge on the +x side. The collet 75 is externally tapered (not indicated by reference numeral) with a smaller diameter on the −x side.

In the configuration described above, as illustrated in FIG. 5C, FIG. 5B, and FIG. 5A in this order, insertion of the collet 75 into the body 73 toward the −x side causes the surface of the tapered portion of the collet 75 to slide against the inner periphery of the body 73. Because of inward pressure received from the inner periphery of the body 73, the collet 75 is reduced in diameter. At the same time, a locking portion 75a (see FIG. 4 and FIG. 5C) on the inner periphery of the collet 75 is brought into engagement with the second large-diameter portion 13e of the connecting member 13 from the +x side. The pipette tip 10 is then drawn into the pipette body 20 and kept from moving toward the +x side.

Conversely, as illustrated in FIG. 5A, FIG. 5B, and FIG. 5C in this order, forcing the collet 75 out of the body 73 toward the +x side causes the locking portion 75a of the collet 75 to push the first large-diameter portion 13d of the connecting member 13 out toward the +x side. At the same time, the collet 75 is increased in diameter by elastic force (or restoring force) while sliding against the inner periphery of the body 73 on the surface of the tapered portion thereof. This brings the locking portion 75a and the second large-diameter portion 13e out of engagement, and allows the connecting member 13 to be moved from the collet 75 toward the +x side and detached.

While not specifically shown, a mechanism for driving the collet 75 in the x direction may also be appropriately set. The mechanism may be one that includes, for example, a spring and/or a solenoid, or may be one that involves using human power, instead of such mechanical power, to drive the collet 75.

When the connecting member 13 is drawn in toward the −x side by the collet 75, the positioning of the connecting member 13 may be done by the collet 75 or by another component. For example, as illustrated in FIG. 4, the pipette body 20 includes a support member 77 disposed adjacent to the proximal end 10b of the pipette tip 10. The support member may be made of an appropriate material, such as resin, ceramic, or metal. The support member 77 has a recessed portion 77r that allows insertion of the protruding portion 13h of the connecting member 13. As described above, at least part of the protruding portion 13h is tapered (not indicated by reference numeral). The recessed portion 77r also has a tapered portion (not indicated by reference numeral) inclined by the same angle as the surface of the tapered portion of the protruding portion 13h. Accordingly, when the connecting member 13 is drawn into the pipette body 20, the protruding portion 13h is inserted into the recessed portion 77r. At the same time, the surface of the tapered portion of the protruding portion 13h slides along the surface of the tapered portion of the recessed portion 77r. This brings the axial center of the connecting member 13 into alignment with the axial center of the support member 77. When the protruding portion 13h is fitted into the recessed portion 77r and stops sliding, the connecting member 13 is kept from moving not only toward the −x side with respect to the support member 77, but also in the direction orthogonal to the x axis.

### [Pipette Body]

The description will now be made with reference back to FIG. 1. As can be understood from the description above, the housing 71, the body 73, the collet 75, and the support member 77 are not individually shown in FIG. 1. That is, these components are schematically illustrated as if they are formed as a single component.

The pipette body 20 has a pressure chamber 21 (cavity) that communicates with the interior of the pipette tip 10. The pipette body 20 reduces the pressure of air inside (or exhausts air from) the pipette tip 10 by increasing the capacity of the pressure chamber 21, and increases the pressure of air inside (or supplies air into) the pipette tip 10 by reducing the capacity of the pressure chamber 21. This enables, for example, the pipette tip 10 to suck and discharge liquid. The pipette body 20 may have any appropriate configuration that enables such operation. An example of the configuration will now be described.

The pipette body 20 includes, for example, a channel member 35 forming a channel (including the pressure chamber 21) that communicates with the interior of the pipette tip 10, an actuator 40 configured to vary the capacity of the pressure chamber 21, and a valve 23 configured to permit or restrict the entry and exit of gas between the exterior and interior of the channel member 35 (channel).

### (Channel Member)

The channel member 35 includes, for example, the support member 77 and the housing 71 described above. The general outer shape and size of the channel member 35 may be appropriately set. In the illustrated example, the channel member 35 has a substantially shaft-like outer shape (longer in the x direction than in the other directions) and is disposed in series with the pipette tip 10. For example, the channel member 35 may have a size (e.g., a maximum outside diameter of 50 mm or less) that allows the user to pick up or hold the channel member 35.

The internal space of the channel member 35 includes, for example, the pressure chamber 21 described above, a communication channel 27 configured to connect the pipette tip 10 to the pressure chamber 21, and an open channel 28 configured to connect the communication channel 27 (or the pressure chamber 21, from another viewpoint) to the outside. At least a portion of the communication channel 27 connected to the pipette tip 10 is formed, for example, in the support member 77 as illustrated in FIG. 4.

The shape, position, and size of the pressure chamber 21 may be appropriately set. In the illustrated example, the pressure chamber 21 is located on a side face of the channel member 35. Also, for example, the pressure chamber 21 is a thin chamber having a substantially uniform thickness in the direction toward the actuator 40 (y direction). The thin chamber means that its length in the y direction is shorter than its maximum length in any other direction orthogonal to the y direction. The planar shape of the pressure chamber 21 (as viewed in the y direction) may be any appropriate shape, such as a circle, an ellipse, a rectangle, or a rhombus. The thickness of the pressure chamber 21 (in the y direction) is, for example, greater than or equal to 50 μm and less than or equal to 5 mm. The diameter of the pressure chamber 21 (i.e., the maximum length in each direction orthogonal to the y direction) is, for example, greater than or equal to 2 mm and less than or equal to 50 mm.

The shapes, positions, and sizes of the communication channel 27 and the open channel 28 may also be appropriately set. For example, the channel member 35 has a first channel 22 extending from the pipette tip 10 in the length direction of the pipette tip 10 (x direction), and a second channel 26 extending from the middle of the first channel 22 in a direction intersecting the first channel 22 to reach the pressure chamber 21. The second channel 26 and a segment of the first channel 22 extending from the point of connection to the second channel 26 toward the pipette tip 10 constitute the communication channel 27. This channel configuration reduces the probability that, for example, liquid (e.g., droplets of the liquid) will enter the pressure chamber 21 and adhere to the actuator 40. Accordingly, this reduces the probability that the operating characteristics of the actuator 40 will be changed by adhesion of liquid to the actuator 40.

Also, for example, the first channel 22 leads to the outside of the channel member 35 on the opposite side of the pipette tip 10. A segment of the first channel 22 extending from the point of connection to the second channel 26 toward the other side of the pipette tip 10 constitutes the open channel 28. Thus, the open channel 28 serves both as a channel for allowing the pressure chamber 21 to open to the outside, and as a channel for allowing liquid to escape to prevent entry of the liquid into the pressure chamber 21. This improves space efficiency.

The cross-sectional shapes and dimensions of the first channel 22 and the second channel 26 may be appropriately set. For example, the first channel 22 and the second channel 26 each have a circular cross section with a diameter greater than or equal to 0.1 mm and less than or equal to 1 mm. The first channel 22 and the second channel 26 have either the same or different inside diameters. The cross-sectional shapes and sizes of the first channel 22 and/or second channel 26 may be uniform or may vary in the length direction.

### (Actuator)

The actuator 40 constitutes, for example, one of the inner surfaces of the pressure chamber 21. The actuator 40 reduces the capacity of the pressure chamber 21 by bending toward the pressure chamber 21 (or in other words, by inwardly displacing the inner surface of the pressure chamber 21). Conversely, the actuator 40 increases the capacity of the pressure chamber 21 by bending toward the opposite side of the pressure chamber 21 (or in other words, by outwardly displacing the inner surface of the pressure chamber 21).

The actuator 40 may have any appropriate configuration that produces bending deformation, such as that described above. For example, the actuator 40 is constituted by a unimorph piezoelectric element. More specifically, for example, the actuator 40 includes a laminate of two piezoelectric ceramic layers 40a and 40b. The actuator 40 also includes an internal electrode 42 and a surface electrode 44 facing each other, with the piezoelectric ceramic layer 40a interposed therebetween. The piezoelectric ceramic layer 40a is polarized in the thickness direction.

When the internal electrode 42 and the surface electrode 44 apply a voltage to the piezoelectric ceramic layer 40a in the same direction as the direction of polarization, the piezoelectric ceramic layer 40a contracts in the planar direction and the piezoelectric ceramic layer 40b does not contract. As a result, the piezoelectric ceramic layer 40a bends toward the piezoelectric ceramic layer 40b. That is, the actuator 40 bends toward the pressure chamber 21. When a voltage is applied in the direction opposite that described above, the actuator 40 bends away from the pressure chamber 21.

The shape and size of the actuator 40 may be appropriately set. For example, the actuator 40 has an appropriate flat planar shape. The planar shape of the actuator 40 may either be similar to or different from the planar shape of the pressure chamber 21. The maximum length in each direction in plan view (as viewed in the y direction) is, for example, greater than or equal to 3 mm and less than or equal to 100 mm. The thickness of the actuator 40 (in the y direction) is, for example, greater than or equal to 20 μm and less than or equal to 2 mm. The materials, dimensions, and shapes of various components of the actuator 40 and the method of applying electricity may also be appropriately set.

### (Valve)

The valve 23 is disposed, for example, at a position from which the open channel 28 leads to the outside. The valve 23 opens and closes to permit and restrict the passage of gas between the interior and exterior of the channel member 35. When the passage of gas is restricted, the pressure in the pipette tip 10 is decreased or increased by varying the capacity of the pressure chamber 21. When the passage of gas is permitted, on the other hand, varying the capacity of the pressure chamber 21 does not decrease or increase the pressure in the pipette tip 10. Accordingly, the amount of decreased pressure can be increased, for example, by decreasing the capacity of the pressure chamber 21 when the passage of gas is permitted, restricting the passage of gas, and then increasing the capacity of the pressure chamber 21. It is also possible to increase the amount of increased pressure.

### (Control Unit)

While not specifically shown, the control unit 24 includes, for example, a central processing unit (CPU), a read-only memory (ROM), a random-access memory (RAM), and an external storage device (or from another viewpoint, an integrated circuit element including at least some of them). The CPU executes a program stored in the ROM and/or the external storage device to implement a functional unit that performs various operations. For example, the control unit 24 is electrically connected to the actuator 40 and the valve 23 to control their operations.

### (Hermeticity Between Pipette Tip and Pipette Body)

The pipette 1 may have packing at appropriate positions to improve hermeticity between the interior of the pipette tip 10 and the interior of the pipette body 20. In the example illustrated in FIG. 4, the pipette 1 has first packing 81 and second packing 83. Note that one or both of the first packing 81 and the second packing 83 are optional.

The first packing 81 and the second packing 83 each are constituted by an O-ring. The material used is, for example, a material with a lower Young's modulus than those of the materials of the connecting member 13 (or connecting member body 14) and the support member 77. For example, the material of the first packing 81 and the second packing 83 may be thermosetting elastomer (rubber in a broad sense) or thermoplastic elastomer. Examples of the thermosetting elastomer include vulcanized rubber (rubber in a narrow sense) and thermosetting resinous elastomer.

The first packing 81 is interposed between the proximal surface 13g of the connecting member 13 and the surface (no reference numeral) of the support member 77 on the distal side. The first packing 81 is firmly attached to and compressed by these surfaces. Before the connecting member 13 is attached, the first packing 81 may be held in place to the pipette body 20 by an appropriate method. For example, the support member 77 has an annular rib 77a that surrounds the protruding portion 13h of the connecting member 13. The outside diameter of the rib 77a is greater than the inside diameter of the first packing 81 under no external forces. Before the connecting member 13 is attached, the first packing 81 is held in place to the pipette body 20, for example, by insertion of the rib 77a.

The second packing 83 is interposed between the top surface of the protruding portion 13h (or the proximal end 13b) of the connecting member 13 and the bottom surface of the recessed portion 77r of the support member 77. The second packing 83 is firmly attached to and compressed by these surfaces. Before the connecting member 13 is attached, the second packing 83 may be held in place to the pipette body 20 by an appropriate method. For example, the inside diameter of the bottom of the recessed portion 77r is smaller than the outside diameter of the second packing 83. Before the connecting member 13 is attached, the second packing 83 is held in place, for example, by being placed at the bottom of the recessed portion 77r.

In the illustrated example, the through hole 11c in the glass tube 11 and the communication channel 27 are spaced apart by the thickness of the second packing 83 in a compressed state. The through hole 11c and the communication channel 27 communicate with each other through the opening in the second packing 83. From another viewpoint, when seen through in the penetrating direction of the through hole 11c (x direction), the second packing 83 surrounds an opening of the through hole 11c at the proximal end 11b, an opening of the through hole 13c in the top surface of the protruding portion 13h, and an opening of the communication channel 27 in the bottom surface of the recessed portion 77r. The diameter of the opening in the second packing 83 may be smaller than, equal to, or greater than the diameters of these openings. For example, the diameter of the opening in the second packing 83 may be greater than or equal to the diameter of the communication channel 27.

As described above, in the present embodiment, the pipette tip 10 that is open at the distal end 10a and the proximal end 10b, which are opposite ends thereof in the length direction, includes the glass tube 11 and the connecting member 13. The glass tube 11 has a first end (distal end 11a) adjacent to the distal end 10a, a second end (proximal end 11b) adjacent to the proximal end 10b, and a first through hole (through hole 11c) extending therethrough from the distal end 11a to the proximal end 11b. The connecting member 13 has a second through hole (through hole 13c) with the glass tube 11 inserted therein. The glass tube 11 is at least partially inserted in the through hole 13c on one side of the center position P1 thereof in the length direction, and is entirely located outside the through hole 13c on the other side of the center position P1 thereof in the length direction. Note here that the one side of the center position P1 is adjacent to the proximal end 11b and the other side of the center position P1 is adjacent to the distal end 11a. The diameter of an end portion (proximal end 13b) of the connecting member 13 opposite the distal end 10a is greater than the diameter of the distal end 10a of the pipette tip 10. The connecting member 13 is made of resin.

Accordingly, for example, the pipette tip 10 can be easily attached to and detached from the pipette body 20. Specifically, for example, since the connecting member 13 is retained by the pipette body 20, it is possible to reduce the probability that the glass tube 11 will be damaged by load applied thereto. In other words, it is possible to reduce the diameter of the glass tube 11 and increase the degree of freedom in the design. Also, since the connecting member 13 is made of resin lower in hardness than glass, it is possible to use the connecting member 13 as packing (unlike the illustrated example). Also, since the connecting member 13 is made of resin, for example, the connecting member 13 can be easily formed into a shape that is suitable for the attaching and detaching mechanism. At the same time, since at least half the length of the glass tube 11, which can easily increase its light transmittance, is located outside the connecting member 13, for example, it is easy to irradiate the liquid in the glass tube 11 with light from the lateral side of the glass tube 11. This makes it easier to carry out, for example, fluorometric analysis.

In the present embodiment, the glass tube 11 has a portion that extends with constant outside and inside diameters on one side of the connecting member 13 adjacent to the distal end 11a (i.e., the entire segment on one side of the connecting member 13 adjacent to the distal end 11a, in the present embodiment).

This makes it easy, for example, to improve accuracy in measuring the properties of the liquid. For example, if the glass tube 11 has a tapered portion and liquid in the tapered portion is to be irradiated with light (such an embodiment may also be included in the technique of the present disclosure), the occurrence of unintended reflection and/or refraction may result in degraded measurement accuracy. The present embodiment can reduce the probability of such degradation of measurement accuracy.

In the present embodiment, the pipette tip 10 further includes the tip member 12. The tip member 12 is secured to the distal end 11a of the glass tube 11 to form the distal end 10a of the pipette tip 10. The tip member 12 is made of resin.

As described above, for example, this makes it easy to adjust the water repellency of the distal end 10a of the pipette tip 10. It is also possible, for example, to easily adjust the amount of liquid adhering to the distal end 10a of the pipette tip 10, and improve the accuracy of measuring the liquid. From another viewpoint, since the pipette tip 10 includes the tip member 12 and the connecting member 13 at both ends thereof, the pipette tip 10 can be considered as being made of glass in the middle. It is thus possible, for example, to irradiate the liquid in the middle of the pipette tip 10 with light from the lateral side. That is, since the pipette tip 10 does not need to retain liquid at both ends thereof, the probability of leakage of liquid from the distal end 10a or the proximal end 10b can be reduced.

In the present embodiment, the connecting member 13 has the first large-diameter portion 13d. The first large-diameter portion 13d is located closer to the distal end 10a of the pipette tip 10 than the proximal end 10b is, and has the largest outside diameter in the pipette tip 10. The center of gravity G1 of the pipette tip 10 is located closer to the proximal end 10b than the first large-diameter portion 13d is.

In this case, for example, when the pipette tip 10 is placed on a horizontal surface, the pipette tip 10 is stabilized, with the outer edge of the first large-diameter portion 13d and the proximal end 10b being in contact with the horizontal surface. That is, the pipette tip 10 is stabilized, with the distal end 10a being in a floating state. This reduces the probability that load will be applied to the glass tube 11 by contact of the distal end 10a with the horizontal surface, and thus reduces the probability that the glass tube 11 will be damaged.

In the present embodiment, the connecting member 13 has the second small-diameter portion 13i. The second small-diameter portion 13i is located closer to the distal end 10a of the pipette tip 10 than the first large-diameter portion 13d is. The second small-diameter portion 13i has an outside diameter greater than the outside diameter of the glass tube 11.

In this case, for example, the glass tube 11 is protected in the following manner. FIG. 4 schematically illustrates a container 91 that opens upward. For example, assume that liquid retained in the container 91 is sucked up, with the distal end 10a of the pipette tip 10 inserted in the opening of the container 91. In this case, when the diameter of the opening of the container 91 (i.e., diameter at the upper end) is smaller than the diameter of the first large-diameter portion 13d and greater than the diameter of the second small-diameter portion 13i, the liquid can be sucked up, with the second small-diameter portion 13i being inserted in the container 91. During sucking, if the pipette tip 10 and the container 91 are moved relative to each other in the y direction, the second small-diameter portion 13i is brought into contact with the inner surface of the container 91. This reduces the probability that the pipette tip 10 will be brought into contact with the inner surface of the container 91 on one side of the connecting member 13 adjacent to the distal end 10a. The probability that load will be applied to the glass tube 11 is also reduced. The glass tube 11 can thus be protected.

In the present embodiment, the connecting member 13 includes the inner layer 15 and the connecting member body 14. The inner layer 15 is configured to surround the outer periphery of the glass tube 11 and made of a first resin. The connecting member body 14 is configured to surround the outer surface of the inner layer 15 to form the outer periphery of the connecting member 13. The connecting member body 14 is made of a second resin different from the first resin. The inner layer 15 has a portion (extending portion 15a) closely adhering to the outer periphery of a portion of the glass tube 11 protruding from the connecting member body 14 toward the distal end 10a of the pipette tip 10.

In this case, for example, in the vicinity of the surface of the connecting member body 14 adjacent to the distal end 10a, the extending portion 15a distributes stress produced between the connecting member body 14 and the glass tube 11. This reduces the probability of occurrence of stress concentration, and protects the glass tube 11. For example, the extending portion 15a can be easily formed of residual of adhesive for bonding the glass tube 11 and the connecting member body 14. Therefore, for example, unlike an embodiment where the connecting member body 14 has a portion corresponding to the extending portion 15a (such an embodiment may also be included in the present disclosure), the extending portion 15a can be formed easily even after a mold for forming the connecting member body 14 is made.

In the present embodiment, the tip member 12, the glass tube 11, and the connecting member 13 may all have light transmitting properties.

For example, this allows visual checking of the position of liquid as described above. Therefore, for example, it is possible to reduce the probability that the liquid will leak from the distal end 10a and/or the proximal end 10b when pressure in the pipette tip 10 is being decreased and/or increased.

In the present embodiment, the attaching and detaching unit 69 includes the collet 75 configured to surround at least part of the connecting member 13 (i.e., a portion closer to the proximal end 13b than the first large-diameter portion 13d is, in the illustrated example).

For example, this allows mechanical attachment and detachment of the connecting member 13 and facilitates attaching and detaching operation. Also, for example, the connecting member 13, which is made of resin, can be easily formed into any shape. This makes it easier to adopt an attaching and detaching method, such as that described above.

In the present embodiment, the connecting member 13 has the protruding portion 13h protruding toward the proximal end 10b of the pipette tip 10. The pipette body 20 (support member 77) has the recessed portion 77r into which the protruding portion 13h is to be fitted. The through hole 13c in the connecting member 13 opens in the top surface of the protruding portion 13h. The communication channel 27 communicating with the through hole 11c in the glass tube 11 opens in the bottom surface of the recessed portion 77r. The O-ring (second packing 83) is interposed between the top surface of the protruding portion 13h and the bottom surface of the recessed portion 77r. When seen through in the penetrating direction of the through hole 11c, the second packing 83 surrounds the opening of the through hole 13c in the top surface of the protruding portion 13h, and the opening of the communication channel 27 in the bottom surface of the recessed portion 77r.

The comparison between the second packing 83 and the first packing 81 shows, in this case, that with the O-ring disposed near the position at which the through hole 11c in the glass tube 11 communicates with the communication channel 27 in the pipette body 20, the volume of airtight space can be reduced. For example, this improves accuracy in decreasing and/or increasing the pressure in the pipette tip 10 and thus improves accuracy in measuring the liquid.

### Second Embodiment

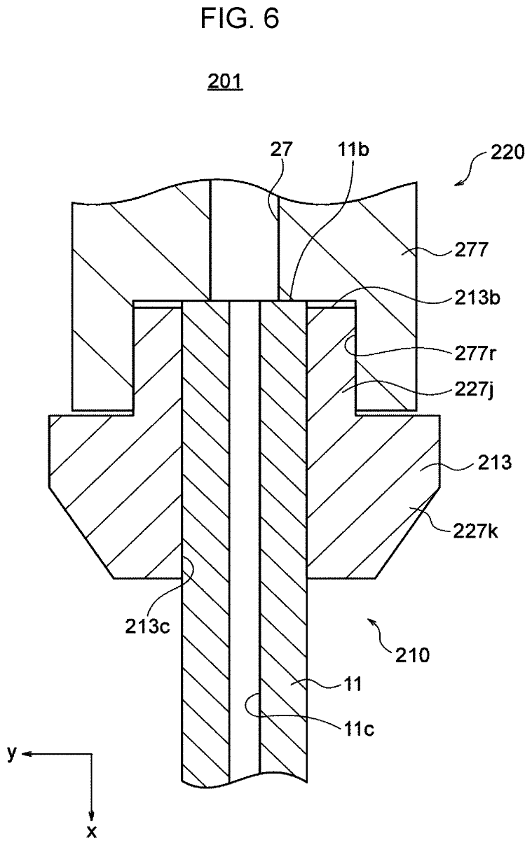

FIG. 6 is a diagram illustrating a configuration of a main part of a pipette 201 according to a second embodiment. FIG. 6 corresponds to a part of FIG. 4. The following description basically refers only to differences between the first and second embodiments. Matters that are not particularly mentioned here may be considered as being the same as the first embodiment, or may be inferred from the first embodiment.

In a pipette tip 210 according to the second embodiment, the glass tube 11 and a connecting member 213 are secured, for example, by press-fitting the glass tube 11 into the connecting member 213. Specifically, for example, the entire connecting member 213 is integrally formed of an elastic material. The connecting member 213 has a through hole 213c configured to allow insertion of the glass tube 11. The through hole 213c has an inside diameter smaller than the outside diameter of the glass tube 11. The connecting member 213 fastens the glass tube 11 with its restoring force to hold the glass tube 11 in place. The connecting member 213 and the glass tube 11 may be provided with an adhesive therebetween.

The connecting member 213 may be made of any appropriate material. For example, the connecting member 213 may be made of thermosetting elastomer (rubber in a broad sense) or thermoplastic elastomer. Examples of the thermosetting elastomer include vulcanized rubber (rubber in a narrow sense) and thermosetting resinous elastomer. Examples of the thermosetting resinous elastomer include silicone rubber. The hardness of the material of the connecting member 213 may also be appropriately set. For example, the material of the connecting member 213 may have a rubber hardness of about 50. The difference between the inside diameter of the connecting member 213 and the outside diameter of the glass tube 11 may also be appropriately set, for example, in accordance with these dimensions and the material (hardness) of the connecting member 213.

In the second embodiment, the connecting member 213 and a pipette body 220 are also secured by press-fitting. Specifically, for example, as in the first embodiment, the pipette body 220 is made of an appropriate material (e.g., resin, ceramic, or metal) and includes a support member 277 having the communication channel 27 formed therein. The support member 277 has a recessed portion 277r at the distal end thereof. The connecting member 213 is constituted by an elastic member, as described above. The connecting member 213 has a press-fit portion 227j with a diameter greater than that of the recessed portion 277r. The press-fit portion 227j is located inside the recessed portion 277r. The press-fit portion 227j presses the inner surface of the recessed portion 277r with its restoring force. The difference between the inside diameter of the recessed portion 277r and the outside diameter of the press-fit portion 227j may be appropriately set in accordance with these dimensions and the material (hardness) of the connecting member 213.

The shape and dimensions of the connecting member 213 (and recessed portion 227r) may be appropriately set. In the illustrated example, the connecting member 213 includes not only the press-fit portion 227j described above, but also a large-diameter portion 227k with a diameter greater than that of the press-fit portion 227j. Note that the large-diameter portion 227k is optional.

In the illustrated example, the press-fit portion 227j and the recessed portion 277r each have, for example, the same cross section (or same diameter) at any position in the x direction. From another viewpoint, the press-fit portion 227j extends in the x direction with a constant thickness (or length from the inner to outer surface). For example, this increases the area of close contact between the press-fit portion 227j and the recessed portion 277r and improves airtightness. Unlike the illustrated example, for example, the press-fit portion 227j may have a tapered shape with a smaller diameter on the proximal side (−x side). For example, this facilitates insertion of the press-fit portion 227j into the recessed portion 277r. When the press-fit portion 227j has a tapered shape, the recessed portion 277r may have the same cross section at any position in the x direction, or may have a diameter that decreases toward the −x side.

The proximal end 11b of the glass tube 11 may be located on the distal side of the proximal end 213b of the connecting member 213, may be flush with the proximal end 213b, or may be located on the proximal side of the proximal end 213b (as in the illustrated example). In the illustrated example, the proximal end 11b is located on the proximal side (−x side) of the proximal end 213b and is in contact with the bottom surface of the recessed portion 277r of the support member 277. For example, this allows direct connection of the through hole 11c in the glass tube 11 to the communication channel 27 in the support member 277, and makes it easier to reduce the volume of airtight space. For example, this improves accuracy in decreasing and/or increasing the pressure in the pipette tip 10 and thus improves accuracy in measuring the liquid. When the glass tube 11 and the support member 277 are in direct contact as described above, for example, the support member 277 may be made of a material (e.g., resin) lower in hardness than glass.

As described above, in the present embodiment, the glass tube 11 is at least partially inserted in the through hole 213c on one side of the center position P1 (between the distal end 11a and the proximal end 11b) adjacent to the proximal end 11b, and is entirely located outside the through hole 213c on the other side of the center position P1 adjacent to the distal end 11a. The diameter of an end portion of the connecting member 213 opposite the distal end of the pipette tip 210 (see, the distal end 10a of the first embodiment) is greater than the diameter of the distal end of the pipette tip 10. The connecting member 13 is made of resin.

Therefore, for example, the same advantageous effects as those in the first embodiment can be achieved. For example, the pipette tip 210 can be easily attached to and detached from the pipette body 220. At the same time, for example, since at least half the length of the glass tube 11, which can easily increase its light transmittance, is located outside the connecting member 13, it is easy to irradiate the liquid in the glass tube 11 with light.

In the present embodiment, the attaching and detaching unit (support member 277) has the recessed portion 277r into which the connecting member 213 is to be press-fitted.

For example, this simplifies the configuration of the attaching and detaching unit, and thus simplifies the configuration of the pipette body 220. It can thus be expected that the cost of making the pipette body 220 will be reduced.

In the first and second embodiments described above, the distal end 11a of the glass tube 11 is an example of a first end. The proximal end 11b of the glass tube 11 is an example of a second end. The through hole 11c in the glass tube 11 is an example of a first through hole. The through hole 13c in the connecting member 13 and the through hole 213c in the connecting member 213 are examples of a second through hole. The first large-diameter portion 13d of the connecting member 13 is an example of a large-diameter portion. The second small-diameter portion 13i of the connecting member 13 is an example of a small-diameter portion. The resin forming the inner layer 15 is an example of a first resin. The resin forming the connecting member body 14 is an example of a second resin. The attaching and detaching unit 69 of the first embodiment and the support member 277 of the second embodiment are examples of an attaching and detaching unit. The second packing 83 is an example of an O-ring.

The technique according to the present disclosure is not limited to the embodiments described above, and may be implemented by various embodiments.

For example, the pipette tip may include only the glass tube and the connecting member, and the tip member may be optional. In other words, the distal end of the pipette tip may be constituted by the distal end of the glass tube (first end).

1. A pipette tip that is open at a distal end and a proximal end, which are opposite ends thereof in a length direction, the pipette tip comprising:
a glass tube having a first end adjacent to the distal end, a second end adjacent to the proximal end, and a first through hole extending therethrough from the first end to the second end; and
a connecting member having a second through hole with the glass tube inserted therein,
wherein the glass tube is at least partially inserted in the second through hole on one side of a center position thereof in the length direction and is entirely located outside the second through hole on the other side of the center position, the one side being adjacent to the second end, the other side being adjacent to the first end; and
a diameter of an end portion of the connecting member opposite the distal end is greater than a diameter of the distal end of the pipette tip, and the connecting member is made of resin.

2. The pipette tip according to claim 1, wherein the glass tube has a portion that extends with constant outside and inside diameters on one side of the connecting member adjacent to the first end.

3. The pipette tip according to claim 1, further comprising a tip member secured to the first end of the glass tube to form the distal end of the pipette tip, the tip member being made of resin.

4. The pipette tip according to any one of claim 1, wherein the connecting member has a large-diameter portion located closer to the distal end of the pipette tip than the proximal end is, the large-diameter portion having the largest outside diameter in the pipette tip; and
a center of gravity of the pipette tip is located closer to the proximal end than the large-diameter portion is.

5. The pipette tip according to claim 4, wherein the connecting member has a small-diameter portion located closer to the distal end than the large-diameter portion is, the small-diameter portion having an outside diameter greater than an outside diameter of the glass tube.

6. The pipette tip according to any one of claim 1, wherein the connecting member includes
an inner layer configured to surround an outer periphery of the glass tube and made of a first resin, and
a connecting member body configured to surround an outer surface of the inner layer to form an outer periphery of the connecting member, the connecting member body being made of a second resin different from the first resin; and
the inner layer has a portion closely adhering to an outer periphery of a portion of the glass tube protruding from the connecting member body toward the distal end.

7. The pipette tip according to claim 3, wherein the tip member, the glass tube, and the connecting member all have light transmitting properties.

8. A pipette comprising:
the pipette tip according to any one of claim 1; and
a pipette body including an attaching and detaching unit to and from which the connecting member is attached and detached.

9. The pipette according to claim 8, wherein the attaching and detaching unit includes a collet configured to surround at least part of the connecting member.

10. The pipette according to claim 8, wherein the attaching and detaching unit has a recessed portion into which the connecting member is press-fitted.

11. The pipette according to claim 9, wherein the connecting member has a protruding portion protruding toward the proximal end;
the pipette body has a recessed portion into which the protruding portion is fitted;
the protruding portion has the second through hole that opens in a top surface thereof;
the recessed portion has a channel that opens in a bottom surface thereof, the channel communicating with the first through hole; and
an O-ring is interposed between the top surface and the bottom surface, the O-ring being configured to surround the opening of the second through hole in the top surface and the opening of the channel in the bottom surface when seen through in a penetrating direction of the first through hole.
